(19) United States
(12) Patent Application Publication
(10) Pub. No.: US 2008/0175947 A1
(43) Pub. Date: Jul. 24, 2008

(54) CUT STRUCTURE FOR MOLD

(75) Inventors: DIAN-HONG WEI, Shenzhen (CN); CHIN-PAI LIN, Shindian (TW)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/937,349

(22) Filed: Nov. 8, 2007

(30) Foreign Application Priority Data
Jan. 19, 2007 (CN) 200710073000.4

(51) Int. Cl. B28B 11/12

(52) U.S. Cl. 425/554; 425/298; 425/553

(57) ABSTRACT

A cut structure for a mold apparatus (100), which the cut structure is configured for being connected to a mold cavity (210), includes a first hole (42), a cut punch (48) and a draw pin (49). The first hole is configured to communicate with the mold cavity. The cut punch is movably received in the first hole for cutting a portion of a molded product. The cut punch defines a second hole (486); and the draw pin is movably received in the second hole of the cut punch. The draw pin has a wedge cutout (492) configured for drawing the portion of a molded product from the mold apparatus.

### BACKGROUND OF THE INVENTION

1. Field of the Invention

The present invention relates to cut structures for molds and, particularly, to a cut structure for a plastic molding mold.

2. Discussion of the Related Art

Most products made of polymers or other plastics are usually formed using injection molding. During a typical injection molding process, a molten material is injected into a mold cavity via a runner. The molten material in the cavity is cooled to form the molded product.

However, if the molten material is directly injected into the mold cavity, resistance from the mold cavity will affect the molten material resulting in flow marks appearing in the final product. Therefore, it is necessary to adopt a gating structure for molded product so as to eliminate defects. The gating structure is generally a structure that connects the runner and the mold cavity.

One kind of typical molded product with a gating structure is represented in FIG. 4. The product 50 includes a gate 51 and a scrap 52. In order to achieve a required product, the gate 51 and the scrap 52 need to be removed through further processing. After removing the gate 51 and the scrap 52, burrs are formed in the surface of the molded product 50. Therefore, the molded product 50 requires to be further smoothed. This not only creates additional working procedures, but also requires more manpower. More seriously, the molded product could possibly be destroyed during the process of removing the gate 51 and the scrap 52.

In order to reduce working steps, a method is adopted to design the position of the gate in a side of a mold cavity. Referring to FIG. 5, the mold apparatus includes a lower mold 2, an upper mold 4 and a cut punch 6. The lower mold 2 and the upper mold 4 are engaged together to cooperatively form a mold cavity 204 therebetween. A runner 206 is in communication with the mold cavity 204. A gate 208 is formed in a distal end of the runner 206. The lower mold 2 defines a through hole 62. The through hole 62 faces the gate 208. The cut punch 6 is received in the through hole 62, and may move toward the gate 208. After the molten plastic is filled with the mold cavity 204, the cut punch 6 moves upward toward the gate 208 so as to cut off the gate 208. Accordingly, the molded product may be formed without a gate. Although the above method may remove the gate 208 in mold, referring to FIG. 6, a scrap 68 is still kept within the molded product 60. The scrap 68 has to be removed through further processing.

Therefore, an improved cut structure is desired in order to overcome the above-described problems.

### SUMMARY

A cut structure for a mold apparatus, which the cut structure is configured to connect to a mold cavity, includes a first hole, a cut punch and a draw pin. The first hole is configured to communicate with the mold cavity. The cut punch is movably received in the first hole for cutting a portion of a molded product. The cut punch defines a second hole; and the draw pin is movably received in the second hole of the cut punch. The draw pin has a wedge cutout configured for drawing the portion of a molded product from the mold apparatus.

Other advantages and novel features of the present cut structure will become more apparent from the following detailed description when taken in conjunction with the accompanying drawing.

### BRIEF DESCRIPTION OF THE DRAWINGS

The components in the drawings are not necessarily drawn to scale, the emphasis instead being placed upon clearly illustrating the principles of the present cut structure. Moreover, in the drawings, like reference numerals designate corresponding parts.

FIG. 1 is a partial cross-sectional view of a mold apparatus including a cut structure in accordance with one embodiment of the present invention;

FIG. 2 is a cross-sectional assembled view of a draw pin and a cut punch

FIG. 3 is a schematic view of a molded product of removing the gate by means of the cut structure of the present invention;

FIG. 4 is a schematic view of a traditional molded product including a gating structure;

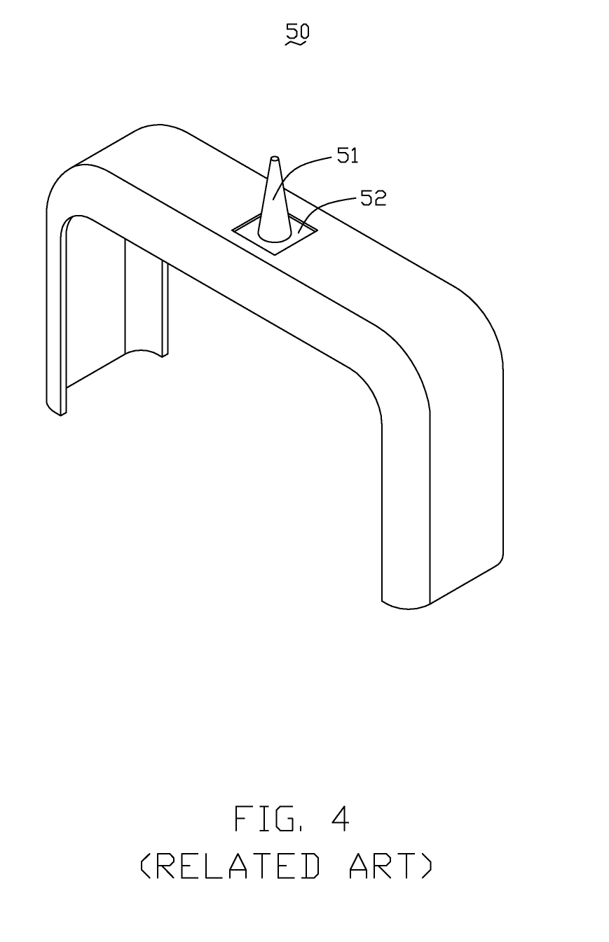

FIG. 5 is a schematic view of a conventional cut structure in mold; and

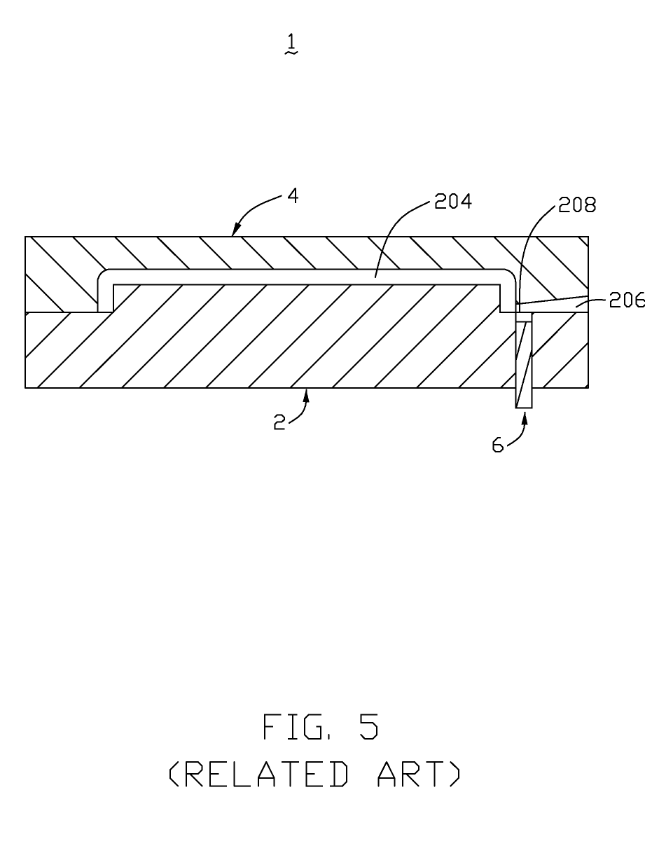

FIG. 6 is a schematic view of a molded product of removing the gate by means of the conventional cut structure.

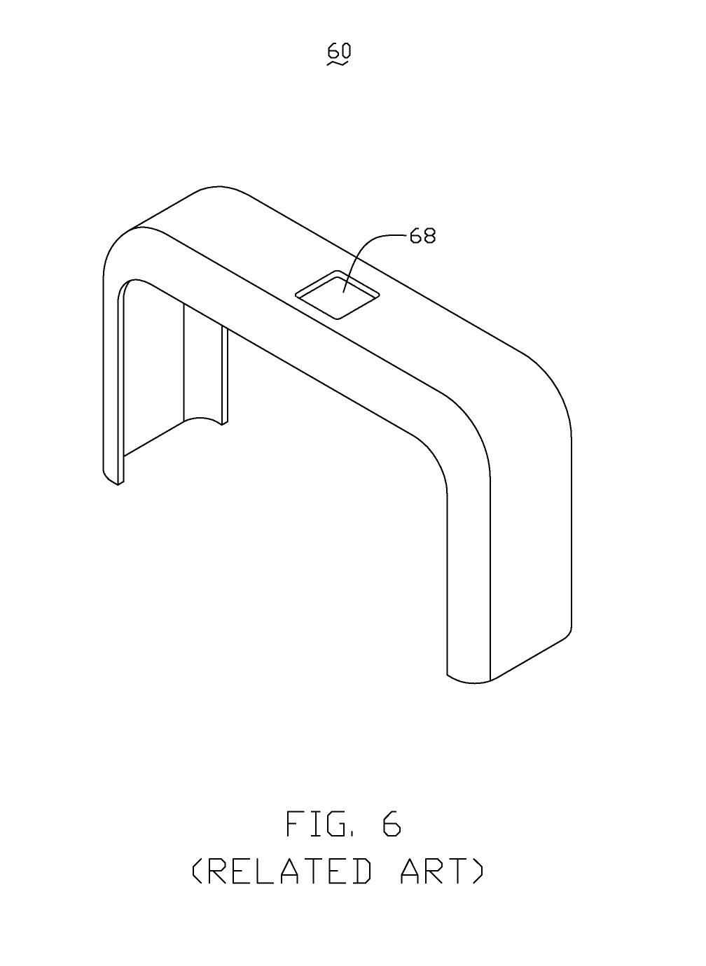

### DETAILED DESCRIPTION OF THE EMBODIMENT

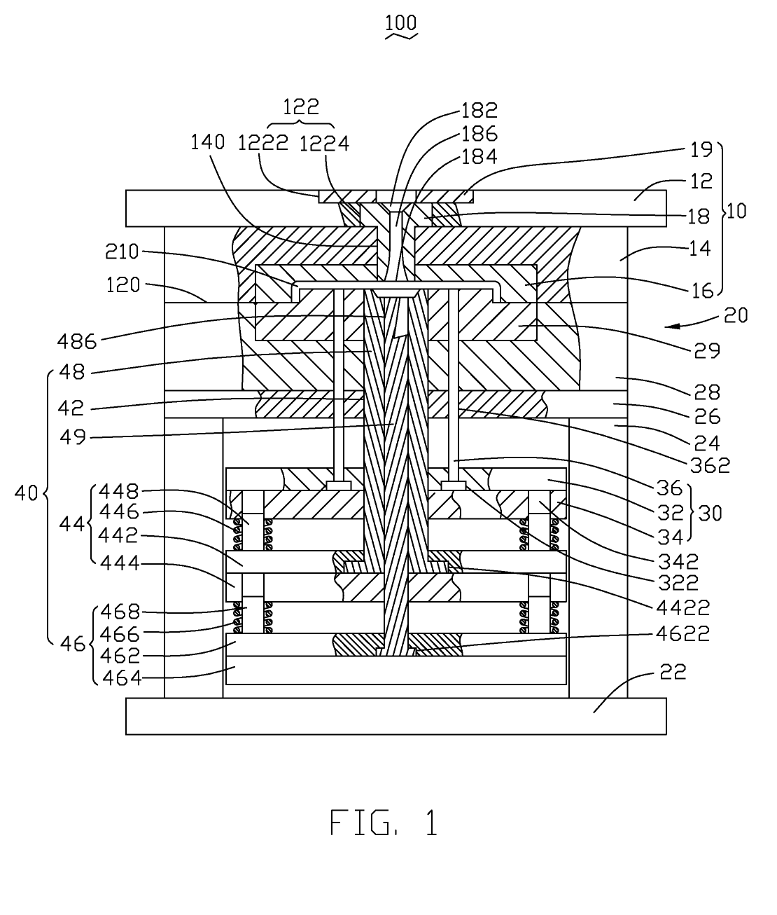

Referring now to the drawings in detail, FIG. 1 shows a cut structure for a mold in accordance with one embodiment of the present invention. In an exemplary application, the cut structure is incorporated in an injection mold apparatus 100.

The injection mold apparatus 100 includes an upper mold 10, a lower mold 20, an ejector structure 30, and a cut structure 40. The upper mold 10 and the lower mold 20 may be separable from each other. When the upper and lower molds 10, 20 are engaged together, a parting plane 120 is formed therebetween.

The upper mold 10 includes an upper fixed plate 12, an upper mold part 14, and an upper mold core 16. The upper fixed plate 12, the upper mold part 14, and the upper mold core 16 are fixed together with screws. The upper mold 10 is fixed to a fixed side of the injection mold apparatus 100.

The upper fixed plate 12 is substantially square, and may be fixed to attach with the injection mold apparatus 100. The upper fixed plate 12 defines an opening 122 in a central area thereof. The opening 122 includes a first hole 1222 and a second hole 1224. A diameter of the first hole 1222 is larger than that of the second hole 1224. The upper mold part 14 defines a recess, and the upper mold core 16 is engaged in the recess. The upper mold part 14 and the upper mold core 16 respectively define a common through hole 140 in central areas thereof. The through hole 140 communicates with the opening 122 of the upper mold core 16.

A bush 18 is inserted into the through hole 140. A bottom end of the bush 18 is received in the through hole 140, and a top end of the bush 18 is received in the second hole 1224. The bush 18 has a sprue 182, a gate 184 and a runner 186 defined in a central area thereof. The sprue 182 is used for seating a nozzle (not shown) of the injector mold apparatus 100, and the molten material may flow into the mold cavity 210 through the runner 186 and the gate 184.

A positioning ring 19 is engaged in the first hole 1222 of the opening 122. The positioning ring 19 may resist the bush 18 so as to prevent the bush 18 breaking off from the opening 122. The positioning ring 19 may help to align the nozzle with the runner 182 of the bush 18.

The lower mold 20 includes a lower fixed plate 22, two spaced blocks 24, a support plate 26, a lower mold part 28, and a lower mold core 29. The lower fixed plate 22, the spaced blocks 24, the support plate 26, the lower mold part 28 and the lower mold core 29 are fixed together with screws. The lower mold 20 is fixed to a movable side of the injection mold apparatus 100.

The lower fixed plate 22 is substantially square-shaped, and fixed to a movable disk (not shown) of the injection mold apparatus 100. Each spaced block 24 is substantially rectangular-shaped, and supported on one of two ends of the lower fixed plate 22. The spaced blocks 24, beneficially, has sufficient height to provide a desired distance between the lower fixed plate 22 and the support plate 26. The support plate 26 is fixed on the two spaced blocks 24. The lower mold part 28 is fixed on the support plate 26. The lower mold part 28 defines a recess, and the lower mold core 29 is engaged in the recess. When the upper and lower mold cores 16 and 29 are engaged together, it cooperatively forms a mold cavity 210 therebetween. The runner 128 communicates with the mold cavity 210 so that molten material such as molten plastic may flow along the runner 128 into the mold cavity 210.

The ejector structure 30 is movably positioned above the lower fixed plate 22, between the two spaced blocks 24. The ejector structure 30 includes an upper ejector plate 32, a lower ejector plate 34, and a plurality of ejector pins 36.

The upper ejector plate 32 defines a plurality of stepped holes 322. The support plate 26, the lower mold part 28 and the lower mold core 29 cooperatively define a plurality of common through holes 362. Each ejector pin 36 extends through a corresponding stepped hole 322, and is movably received in a corresponding through hole 362. The lower ejector plate 34 is fixed on a bottom side of the upper ejector plate 32. Thus one end of each ejector pin 36 is locked into the corresponding stepped hole 322 by the lower ejector plate 34, so as to fix all the ejector pins 36 in the ejector structure 30.

The cut structure 40 includes an inner cut hole 42, a first support structure 44, a second support structure 46, an inner cut punch 48 and a draw pin 49.

The inner cut hole 42 is a circular hole, and defined in a central area of the support plate 26, the lower mold part 28, the lower mold core 29, the upper ejector plate 32 and the lower ejector plate 34.

The first support structure 44 and the second support structure 46 are positioned between the two spaced blocks 24, under the lower ejector plate 34. The first support structure 44 includes an upper board 442, a lower board 444, two springs 446 and two screws 448.

The upper board 442 is disposed under the lower ejector plate 34. The upper board 442 defines a received hole 4422. The receive hole 4422 communicates with the inner cut hole 42. One end of the inner cut punch 48 is received in the received hole 4422, the other end of the inner cut punch 48 is received in the inner cut hole 42. The lower board 444 and the upper board 442 are fixed together. The lower ejector plate 34 defines two guide holes 342. A diameter of the guide holes 342 is slightly larger than that of the screws 448. A bottom end of each screw 448 is fixed to the upper board 442, and a top end of each screw 448 is movably received in a corresponding guide hole 342. A portion of each screw 48 below the lower ejector plate 34 is surrounded by a corresponding spring 446. A diameter of each spring 446 is larger than that of each guide hole 342. Accordingly, the springs 446 resist both the lower ejector plate 34 and the upper board 442. If the upper board 442 and the lower board 444 are pressed upward, the upper board 442 and the lower board 444 will move together relative to the upper ejector plate 32 and the lower ejector plate 34, with the screws 48 sliding along the guide holes 342.

The structure of the second support structure 46 is similar to that of the first support structure 44, and includes an upper holder 462, a lower holder 464, two springs 466 and two screws 468. The upper holder 462 is disposed above the lower board 444, and defines a stepped hole 4622. The stepped hole 4622 is configured for receiving one end of the draw pin 49. The lower holder 464 and the upper holder 462 are fixed together, and the lower holder 464 resists the draw pin 49 so as to avoid the drawn pin 49 separating from the second support structure 46. The two springs 466 and the two screws 468 are similar to those of the first support structure 44, which are not detailed herein.

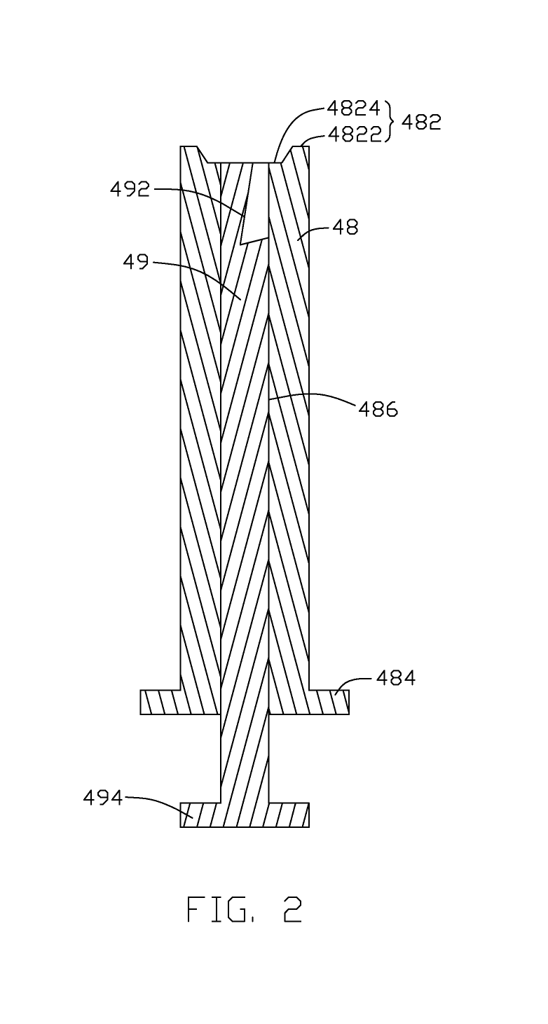

Referring to FIG. 2, the inner cut punch 48 is substantially a cylinder. One end of the inner cut punch 48 forms a concave portion 482. The concave portion 482 has a brim portion 4822 and a bottom portion 4824. The brim portion 4822 and the bottom portion 4824 cooperatively define a reverse trapezium. A width of the brim portion 4822 is small so as to be used to cut a to-be-cut portion of a molded product in mold. The other end of the inner cut punch 48 has a flange 484. The flange 484 may engage in the received hole 4422. The inner cut punch 48 defines a through hole 486 therein for movably receiving the drawn pin 49.

The draw pin 49 is substantially a cylinder. One end of the draw pin 49 has a wedge cutout 492, and the other end of the draw pin 49 has a flange 494. The wedge cutout 492 is used for snapping the gate connected with the runner 186. The flange 494 is received in the stepped hole 4622.

In use, the upper mold 10 and the lower mold 20 are closed. When the molten plastic is injected, the molten plastic firstly injects to the mold cavity 210 from the nozzle of the mold apparatus 100. Then, the molten plastic flows into to the runner 186 from the sprue 182 of the bush 18. The molten plastic further flows into the mold cavity 210 from the gate 184. After the molten plastic has filled the whole mold cavity 210, the concave portion 482 and the wedge cutout 482, and when the molten plastic is not completely solidified, the first support structure 44 and the second support structure 46 are driven toward the upper mold core 16 at the same speed so as to move the inner cut punch 48 and the draw pin 49. When the brim portion 4822 of the inner cut punch 48 contacts with the upper mold core 16, the product scrap in the concave portion 482 and the wedge cutout 492 is cut off from the molded product.

After that, the lower mold 20 moves downward. Owing to the molded product scrap with the gate 184 is adhered to the concave portion 482 and the wedge cutout 492, when the lower mold 20 with the cut punch 48 and the draw pin 49 move downward, the molded product scrap is separated from the molded product, and the gate 184 is drawn off from the runner 186. Accordingly, the gate 184 is separated from the upper mold 10. Then, the second support structure 46 is driven so as to make the draw pin 49 move relative to the inner cut punch 48. The wedge cutout 492 extends out from the through hole 486. Accordingly, the product scrap and the gate 184 are drawn from the concave portion 482. Finally, the upper ejector plate 32, the second ejector plate 34 are moved together by a back rod (not shown) of the injection mold apparatus 100 so as to make the ejector pins 36 move up and push the solidified plastic piece. Thus, the molded product is pushed out from engagement with the lower mold core 29.

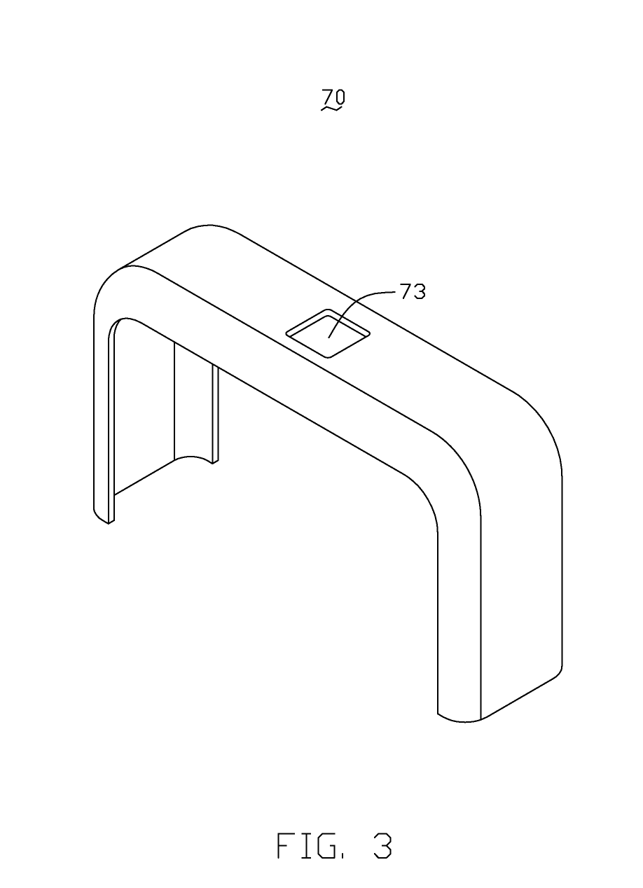

Referring to FIG. 3, a molded product 70 has removed the scrap and the gate so as to form a hole 73 through the above method. The molded product 70 by means of the above method not only reduces more process steps, and but also increases produce efficiency.

As described above, the cut structure is configured to allow the gate and the scrap in the mold cavity 210 to be cut therein. A main advantage of the cut structure is that the molded product has not only directly achieved the desired structure, it has also achieved a good appearance. In addition, the cut structure is simple and may greatly improve the product quality at relatively little cost.

The above-described cut structure can be used with other kinds of molding apparatuses besides the injection mold apparatus 100 illustrated, or with other kinds of apparatuses that require a cut structure. The products formed can have good mechanical strength as well as a smooth, attractive appearance.

It is believed that the present embodiment and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A cut structure for a mold apparatus, the mold apparatus defining a first hole and a mold cavity, the first hole being in communication with the mold, the cut structure comprising:
a cut punch movably received in the first hole for cutting a to-be-cut portion of a molded product formed in the mold apparatus, the cut punch defining a second hole; and
a draw pin movably received in the second hole of the cut punch, the draw pin having a wedge cutout configured for drawing the to-be-cut portion of the molded product from the mold apparatus.

2. The cut structure as claimed in claim 1, wherein one end of the cut punch includes a concave portion that includes a brim portion and a bottom portion, and the brim portion and the bottom portion cooperatively define a reverse trapezium.

3. The cut structure as claimed in claim 1, further comprising a first support structure and a second support structure, the cut punch being attached to the first support structure, and the draw pin being attached to the second support structure.

4. The cut structure as claimed in claim 3, wherein the first support structure includes an upper board and a lower board, and the upper and the lower board cooperatively support the cut punch.

5. The cut structure as claimed in claim 3, wherein the second support structure includes an upper holder and a lower holder, and the upper and the lower holder cooperatively support the draw pin.

6. A mold apparatus comprising:
an upper mold;
a lower mold cooperating with the upper mold to define a mold cavity therebetween, the lower mold defining a first hole configured to communicate with the mold cavity;
a cut punch movably received in the first hole for cutting a to-be-cut portion of a molded product, the cut punch defining a second hole; and
a draw pin movably received in the second hole of the cut punch, the draw pin having a wedge cutout configured for drawing the to-be-cut portion of the molded product from the upper mold.

7. The mold apparatus as claimed in claim 6, wherein one end of the cut punch comprises a concave portion that comprises a brim portion and a bottom portion, and the brim portion and the bottom portion cooperatively define a reverse trapezium.

8. The mold apparatus as claimed in claim 6, further comprising a first support structure and a second support structure, the cut punch being attached to the first support structure, and the draw pin being attached to the second support structure.

9. The mold apparatus as claimed in claim 8, wherein the first support structure includes an upper board and a lower board, and the upper and the lower board cooperatively support the cut punch.

10. The mold apparatus as claimed in claim 8, wherein the second support structure includes an upper holder and a lower holder, and the upper holder and the lower holder cooperatively support the draw pin.

11. The mold apparatus as claimed in claim 6, further comprising an ejector structure, a first support structure and a second support structure, the cut punch being attached to the first support structure, the draw pin being attached to the second support structure, and the ejector structure being positioned below the lower mold and above the first support structure.

12. The mold apparatus as claimed in claim 11, wherein the ejector structure comprises an upper ejector plate, a lower ejector plate, and a plurality of ejector pins, and the ejector pins are attached on the upper ejector plate and the lower ejector plate.

13. The mold apparatus as claimed in claim 12, wherein the first support structure comprises an upper board, a lower board and at least one screw, and the upper and the lower board cooperatively support the cut punch, and the at least one screw is positioned between the lower ejector plate and the upper board.

14. The mold apparatus as claimed in claim 13, wherein the lower ejector plate defines at least one guide hole, and one end of the at least one screw is movably received in the at least one guide hole.

15. The mold apparatus as claimed in claim 14, wherein the first support structure further comprises at least one spring, wherein the at least one spring is located around the at least one screw.

16. The mold apparatus as claimed in claim 15, wherein the second support structure comprises an upper holder, a lower holder and at least one screw, and the upper and the lower holder cooperatively support the draw pin, and the at least one screw is positioned between the lower board and the upper holder.

17. The mold apparatus as claimed in claim 16, wherein the second support structure further comprises at least one spring, the lower board defines at least one guide hole, and one end of the at least one screw is movably received in the at least one guide hole, and the at least one spring is located around the at least one screw.
